(19) United States
(12) Patent Application Publication
(10) Pub. No.: US 2016/0162710 A1
(43) Pub. Date: Jun. 9, 2016

(54) INFORMATION HANDLING OF ACCESS SECURITY

(71) Applicant: International Business Machines Corporation, Armonk, NY (US)

(72) Inventors: Wei-Tien Chen, Taipei (TW); Yulianti Darmanto, Taipei (TW); Cheng-Hao Lin, Taipei (TW); Yu-Kang Liu, Taipei (TW); Bruce Alan Smith, Redmond, WA (US); Hui Wen Tsai, Taipei (TW)

(21) Appl. No.: 15/040,559

(22) Filed: Feb. 10, 2016

Related U.S. Application Data
(63) Continuation of application No. 14/617,502, filed on Feb. 9, 2015.

(30) Foreign Application Priority Data
Mar. 31, 2014 (TW) 103112025

(51) Int. Cl. G06F 21/86; H04W 12/08; H04W 12/06; G07C 9/00

(52) U.S. Cl. CPC G06F 21/86; G07C 9/00182; H04W 12/08; H04W 12/06

(57) ABSTRACT

A method of effectuating access security includes sending authentication data with a specific lifetime from a mobile device to an information handling system. The information handling system includes a controller and a housing. The housing includes a chassis and a latch component, with the controller electrically coupled to the latch component. The method includes determining by the controller in accordance with the authentication data whether the mobile device is authorized to activate the latch component and activating the latch component by the controller to lock or unlock the housing in response to a determination that the mobile device is authorized to activate the latch component.

### CROSS-REFERENCE TO RELATED APPLICATIONS

This patent application claims priority to Taiwan Patent Application No. 103112025 filed on Mar. 31, 2014 for Wei Tien Chen, et al., the entire contents of which are incorporated herein by reference for all purposes.

### FIELD

The present invention relates to information handling, and more particularly, to an information handling system, a method, and a computer program product of access security.

### BACKGROUND

Information technology environments are predisposed to the risk of loss of or unauthorized access to an electronic device, such as an information handling system, a server, a hard disk drive, a memory, a central processing unit (CPU), and a USB flash drive. Take an information handling system as an example, its loss or unauthorized use not only leads to hardware damage or abuse but also poses a problem with data or software protection, for example, protection of personal data, highly confidential messages, and software program code.

In general, a key-operated lock is disposed at a chassis of an information handling system to perform locking and protective operations and protect hardware/software/data against malicious theft. End users perform locking/unlock operations with a related key when repairing or accessing the information handling system.

The aforesaid solution requires end users to take care of the key. However, the key is not only inconvenient to take care of but also susceptible to malicious replication and theft. There is no way to dig out the past of the key. Furthermore, the aforesaid inconvenience encourages end users to give up the key. As a result, the aforesaid solution has severe information security pitfalls.

### BRIEF SUMMARY

In one aspect, the present invention provides novel security control management of an information handling system to effectively carry out security control management and effectuate complete recording and analysis through logging and timestamp in accordance with authentication data with a specific lifetime.

The present invention, in an embodiment thereof, provides a method of effectuating access security of an information handling system with a mobile device. The information handling system comprises a controller and a housing. The housing comprises a chassis and a latch component. The controller is electrically coupled to the latch component. The method comprises the steps of: sending authentication data with a specific lifetime from the mobile device to the information handling system; determining by the controller in accordance with the authentication data whether the mobile device is authorized to activate the latch component; and activating the latch component by the controller to lock or unlock the housing in response to an affirmative determination.

The present invention, in another embodiment thereof, provides a computer program product for use in effectuating access security of an information handling system through a mobile device. The computer program product comprises a program command stored therein to implement the method.

The present invention, in yet another embodiment thereof, provides an information handling system capable of effectuating access security of an information handling system through a mobile device. The information handling system comprises: a housing comprising a chassis and a latch component; and a controller electrically coupled to the latch component to controllably enable the latch component to be at one of a locked position and an unlocked position to thereby lock or unlock the housing, respectively, wherein, in response to the mobile device's sending authentication data with a specific lifetime to the information handling system, the controller makes reference to the authentication data and determines whether the mobile device is authorized to activate the latch component, wherein, in response to the mobile device's being authorized, the controller activates the latch component.

The features, advantages and similar expressions disclosed in this specification do not mean that all the features and advantages realized by the present invention should be within any single embodiment of the present invention. It should be noted that the expressions regarding to the features and advantages indicate those specific features, advantages or characteristics described in connection with embodiments are included in at least one embodiment of the present invention. Therefore, the descriptions regarding to the features, advantages and similar expressions in the specification are related to the similar embodiments, but not necessarily.

These features and advantages can be further understood by referring to the description below and attached claims or using the Detailed Description of the present invention described below.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a perspective view of an information handling system according to a specific embodiment of the present invention;

FIG. 2 is a schematic view of a hardware framework of the information handling system according to a specific embodiment of the present invention; and

FIG. 3 is a flow chart of a method according to a specific embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

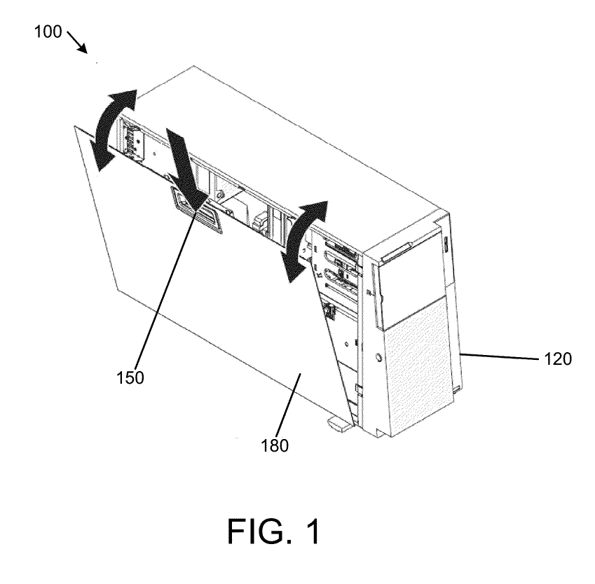

Referring now to FIG. 1 through FIG. 3, systems/devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

A method of effectuating access security includes sending authentication data with a specific lifetime from a mobile device to an information handling system. The information handling system includes a controller and a housing. The housing includes a chassis and a latch component, with the controller electrically coupled to the latch component. The method includes determining by the controller in accordance with the authentication data whether the mobile device is authorized to activate the latch component, and activating the latch component by the controller to lock or unlock the housing in response to a determination that the mobile device is authorized to activate the latch component.

In one embodiment, the method includes determining whether the mobile device is authorized is performed by an authentication process in accordance with the authentication data. In another embodiment, the method includes determining by the controller that the specific lifetime of the authentication data has elapsed, performing logging and timestamp by the controller and sending information regarding failure of the authentication process and that the information handling system remains locked from the controller to the mobile device in response to one or more of the elapse of the specific lifetime of the authentication data and the failure of the authentication process, and in response to the information handling system remaining locked, and performing the authentication process in response to the determination that the specific lifetime of the authentication data has not elapsed.

In another embodiment, the method includes keeping, by the controller, the latch component at a locked position to continue locking the housing in response to authentication failure of the authentication process, and activating, by the controller, the latch component to an unlocked position to unlock the housing in response to authentication success of the authentication process. In another embodiment, the method includes determining by the controller whether the specific lifetime has elapsed, and invalidating the authentication data and activating the latch component to the locked position by the controller in response to an elapse of the specific lifetime.

In one embodiment, the controller includes an integrated management module (IMM), a baseboard management controller (BMC), or a service processor. In another embodiment, the mobile device includes a cell phone, a portable authentication device, or a universal serial bus (USB) flash drive, where the housing includes a cover, and the latch component activates to lock the cover and the chassis.

An information handling system includes a housing comprising a chassis and a latch component, and a controller electrically coupled to the latch component to controllably enable the latch component to be at one of a locked position and an unlocked position to thereby lock or unlock the housing, respectively. In the embodiment, in response to a mobile device sending authentication data with a specific lifetime to the controller, the controller determines from the authentication data whether the mobile device is authorized to activate the latch component, where, in response to the mobile device's being authorized, the controller activates the latch component to the unlocked position.

In one embodiment, determining whether the mobile device is authorized is effectuated by an authentication process in accordance with the authentication data. In another embodiment, the controller determines whether the specific lifetime of the authentication data with a specific lifetime has elapsed, where the controller performs logging and timestamp and sends information regarding the authentication process failure and that the information handling system remains locked to the mobile device in response to an elapse of the specific lifetime of the authentication data and/or the authentication process failure, and in response to the information handling system remaining locked. The controller performs the authentication process in response to a determination that the specific lifetime of the authentication data has not elapsed.

In another embodiment, the controller keeps the latch component at a locked position to continue locking the housing in response to authentication failure of the authentication process, and the controller activates the latch component to an unlocked position to unlock the housing in response to authentication success of the authentication process. In another embodiment, the controller determines whether the specific lifetime has elapsed, where the controller invalidates the authentication data and activates the latch component to the locked position in response to an elapse of the specific lifetime. In another embodiment, the controller includes an integrated management module (IMM), a baseboard management controller, or a service processor. In another embodiment, the mobile device includes one of a cell phone, a portable authentication device, or a universal serial bus (USB) flash drive, where the housing includes a cover and the latch component activates to lock the cover and the chassis.

A computer program product for effectuating security access is included, where the computer program product includes a computer readable storage medium having program instructions embodied therewith, and the program instructions are executable by a processor to cause the processor to determine by the controller that the specific lifetime of the authentication data has elapsed, and to perform logging and timestamp by the controller and sending information regarding failure of the authentication process and that the information handling system remains locked from the controller to the mobile device in response to the elapse of the specific lifetime of the authentication data or the failure of the authentication process, and in response to the information handling system remaining locked. The program instructions are executable by a processor to perform the authentication process in response to the determination that the specific lifetime of the authentication data has not elapsed.

In one embodiment, the program instructions further cause the processor to determine by the controller that the specific lifetime of the authentication data has elapsed, to perform logging and timestamp by the controller and sending information regarding failure of the authentication process and that the information handling system remains locked from the controller to the mobile device in response to the elapse of the specific lifetime of the authentication data or the failure of the authentication process, and in response to the information handling system remaining locked, and to perform the authentication process in response to the determination that the specific lifetime of the authentication data has not elapsed.

In another embodiment the program instructions further cause the processor to keep, by the controller, the latch component at a locked position to continue locking the housing in response to authentication failure of the authentication process, and to activate, by the controller, the latch component to an unlocked position to unlock the housing in response to authentication success of the authentication process. In another embodiment, the program instructions further cause the processor to determine by the controller whether the specific lifetime has elapsed, and to invalidate the authentication data and activating the latch component to the locked position by the controller in response to an elapse of the specific lifetime. In one embodiment, the controller includes an integrated management module (IMM), a baseboard management controller (BMC), or a service processor. In another embodiment, the mobile device includes a cell phone, a portable authentication device, or a universal serial bus (USB) flash drive, where the housing further comprises a cover, and the latch component activates to lock the cover and the chassis.

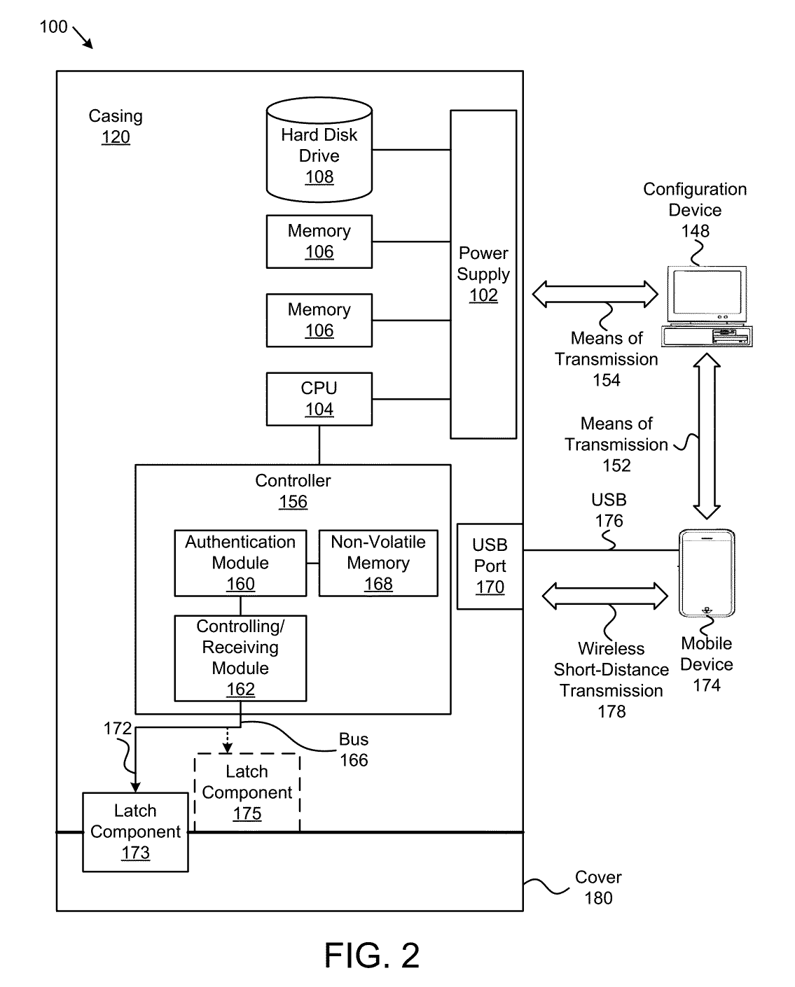

FIG. 1 is a perspective view of an information handling system 100 according to a specific embodiment of the present invention. The information handling system 100 is, for example, a server which typically comprises a casing 120, and an openable or removable cover 180 or panel, so as to provide a mechanism for accessing (for example, changing and mounting) circuits, parts and components in the casing 120. The casing 120 is equipped with a latch component 172 (shown in FIG. 2) and coupled to an access security control mechanism (illustrated with FIG. 2) of the latch component 172 so as to control the latching of the latch component 172 and further protect hardware, software, and/or data against malicious theft. Details of access, security, control, and protection are explained later. The latch component 172 is a conventional latch component and thus is not described in detail herein for the sake of brevity. The cover 180 has a dent portion 150. After the cover 180 has been unlocked from the casing 120, the dent portion 150 assists the user's fingers in applying a force to move the cover 180. To begin a latching process, the user's fingers exert a force on the dent portion 150 to move the cover 180 to a locked position for performing a locking operation. Alternatively, the information handling system 100 is optionally equipped with a conventional key-operated lock or locking device (not shown) to provide further protection, but the present invention is not limited thereto.

Referring to FIG. 2, there is shown a schematic view of a hardware framework of the information handling system 100. The information handling system 100 further comprises a power supply 102, a central processing unit (CPU) 104, a memory module 106, a hard disk drive 108, a controller 156, and a USB port 170. The components shown in FIG. 2 can be common conventional components which are interconnected and programmed to provide required functions. For the other basic frameworks and components of the information handling system 100, refer to conventional personal computers and servers, such as IBM's® IBM System X®, eServer xSeries, and any other servers, and refer to IBM's System x system described in U.S. Patent Publication No. 2009/0150693, for Vivek Kashyap, et al on Dec. 5, 2007, filed by the Applicant of this patent application, which is hereinafter incorporated by reference for all purposes. Details irrelevant to the present invention are omitted.

In the embodiment illustrated with FIG. 1, when the information handling system 100 is operating, the power supply 102 supplies DC power to the CPU 104, the memory module 106, the hard disk drive 108, and the controller 156. The controller 156 is programmable and capable of input/output (I/O). The controller 156 typically comprises a typical microprocessor (not shown), for example, a microprocessor which has a plurality of I/O channels, a non-volatile memory 168, an authentication module 160, and a controlling/receiving module 162. The authentication module 160 is, for example, a program code segment or a chip capable of authentication. The controlling/receiving module 162 is, for example, a program code segment or a micro control chip. In practice, the authentication module 160 and the controlling/receiving module 162 each come in the form of a standalone IC or are integrated into the controller 156, but the present invention is not limited thereto.

In a preferred embodiment, the CPU 104, the controller 156, and the like are mounted on a motherboard (not shown), and the controller 156 is a service processor on the motherboard. In an embodiment, the service processor is preferably a baseboard management controller (BMC), an integrated management module (IMM), or any other service processor. Take the BMC as an example, for its details, refer to VSC452 BMC from Maxim® or SE-SM4210-P01 BMC from ServerEngines. Take the IMM as an example, for its details, refer to IBM's IMM, Integrated Lights Out (iLO) IMM from HP®, and Dell Remote Access Card (DRAC) IMM from Dell®, as well as U.S. Patent Publication No. 2011/0320826, for Charles R. Simmons, et al. on Dec. 29, 2011, filed by the Applicant of this patent application, which is hereinafter incorporated by reference for all purposes, to make further modification and extension.

In a preferred embodiment, the controller 156 is electrically coupled to the latch component 172 through a bus 166 and adapted to control the operation of the latch component 172. The controlling/receiving module 162 of the controller 156 sends a control signal to the latch component 172 to issue the latch component 172 a command under which the latch component 172 assumes a locked position 173 or an unlocked position 175, such that the chassis 120 and the cover 180 work together to effectuate the locking and unlocking of the casing of the information handling system 100. The authentication module 160 of the controller 156 authenticates user information, user identity, purpose, and expiry date of a mobile device 174. If the authentication of the user information pertaining to the mobile device 174 fails, the latch component 172 will do nothing, whereas the casing 120 and the cover 180 of the information handling system 100 are in a locked status. The mobile device 174 includes but is not limited to a cell phone, a portable authentication device, and a USB flash drive.

In a preferred embodiment, the authentication module 160 effectuates authentication of public-key cryptography and a symmetric-key algorithm, for example. Typically, public-key cryptography enables a sender, who must know a receiver's public key in order to send the receiver encrypted information that can only be read by the receiver, to access a pair of keys (i.e., public key and private key) which differ but match and encrypt the original with the receiver's public key, and enables the receiver to receive the encrypted original and decrypt it with the receiver's private key. The symmetric-key algorithm includes an encryption algorithm and a reverse algorithm. After the sender has processed the original data and encryption key with the encryption algorithm, the original is converted into an encrypted original which is then sent to the receiver. To read the received encrypted original, the receiver restores the original data by decrypting the encrypted original with the reverse algorithm which involves using the same algorithm and key previously used in encryption. The aforesaid encryption techniques are attributed to the prior art in this field and thus are well-known among persons skilled in the art. In addition, any known encryption techniques and/or structures can be applied to the present invention but are not described herein for the sake of brevity.

The non-volatile memory 168 includes but is not limited to a flash ROM and a non-volatile electrically erasable programmable read-only memory (EEPROM). The non-volatile memory 168 comprises a protected area and a flashable area. The protected area stores therein unerasable code, including but not limited to important product-related data or vital product data (VPD), authentication information, and additional function information. The flashable area stores data, including but not limited to used key-related information. The non-volatile memory 168 of the controller 156 also stores firmware required for controlling or configuring the latch component 172 and related parameters, for example, key length, expiry date, authentication method, and any other parameters of the CPU 104. The aforesaid techniques are attributed to the prior art and thus well-known among persons skilled in the art.

Referring to FIG. 2, in an embodiment, a configuration device 148, such as a desktop computer, a handheld mobile phone, a notebook computer, a tablet, or a mobile device of any type, configures authentication data, including but not limited to paired keys (public key and private key) with a specific lifetime. An administrator or user uses the configuration device 148 to generate authentication data with a specific lifetime. Due to the authentication data, it is effective to perform unlocking operation on the latch component 172 and access the software/hardware of the information handling system 100. The authentication data generated with the configuration device 148 is sent to the mobile device 174 by a means of transmission 152 and sent to the information handling system 100 by a means of transmission 154. Examples of the means of transmission 152 and the means of transmission 154 include a USB port, a serial port, Bluetooth, NFC, and infrared. The mobile device 174 and the information handling system 100 communicate by cable transmission (including but not limited to the USB port 170 and a USB line 176) or by wireless short-distance transmission 178 (including but not limited to Bluetooth and NFC).

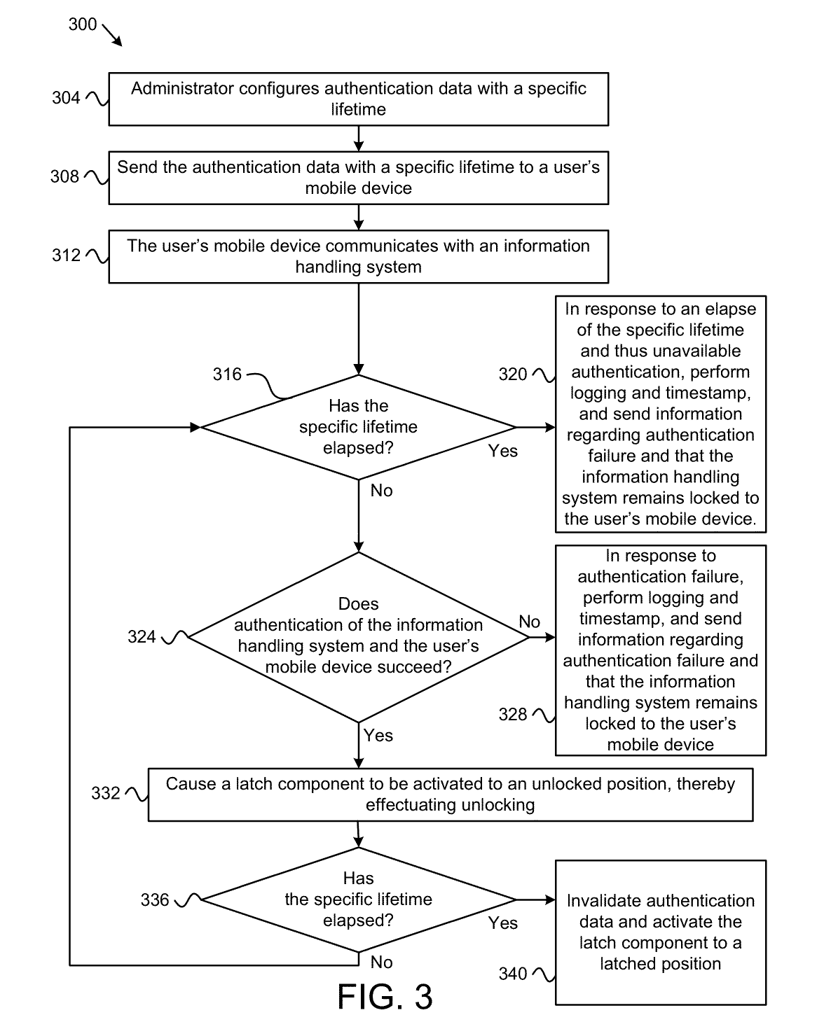

The controller 156 has one or more signal ports (not shown) for sending a control signal to the latch component 172 to further control the latching operation or latching configuration of the latch component 172. For example, the controller 156 sends different digital logical signals to the controlling/receiving module 162 of the latch component 172 such that the digital logical signals function as the control signals of the latch component 172 to therefore control the latching or unlocking operation of the latch component 172. In this regard, related details are illustrated with a flow chart of FIG. 3. Furthermore, the controller 156 can have one or more signal ports (not shown) for receiving signals from the latch component 172.

A security control method 300 for use with the information handling system 100 according to an embodiment of the present invention is hereunder illustrated with the hardware framework shown in FIG. 1 and FIG. 2 and a flow chart of FIG. 3.

Step 304: a configuration user (such as a system administrator or a typical user) of the configuration device 148 generates authentication data with a specific lifetime, for example, paired keys (public key and private key) with a specific lifetime, from an embedded system (not shown) or an authentication data generating module (not shown) of the configuration device 148. In an embodiment, the configuration device 148 further comprises a control interface module (not shown) and the authentication data generating module which operate in conjunction with each other. The generation of authentication data with a control interface module, using conventional techniques pertaining to authentication data, is well-known among persons skilled in the art and thus is not described in detail herein for the sake of brevity.

Step 308: the configuration user of the configuration device 148 sends the authentication data with a specific lifetime (in an embodiment, it includes but is not limited to authentication data with a specific lifetime and of any encryption format) to the storage medium of the mobile device 174 or any storage medium of an authorized user. In a preferred embodiment, the configuration user of the configuration device 148 sends a public key with a specific lifetime to any storage medium of the authorized user through the means of transmission 152. On the other hand, the configuration user of the configuration device 148 sends a private key with a specific lifetime to the authentication module 160 of the information handling system 100 through the means of transmission 154. The authorized user is defined as a user authorized by the system administrator, for example, a service engineer, a R&D engineer, and a product engineer. Examples of the means of transmission 152 and the means of transmission 154 include a USB port, a serial port, Bluetooth, and NFC. In an embodiment, a public key, which is expressed in the form of QR code scanned with the mobile device 174, is sent to any storage medium, including but not limited to the storage medium of the mobile device 174, or sent with a USB storage device and a USB port.

Step 312: the authorized user communicates with the authentication module 160 of the information handling system 100 by a storage medium which stores authentication data. In an embodiment, the authorized user performs communication at a remote end, allows the storage medium to approach the information handling system 100, performs communication by cable communication through the USB port 170 and the USB line 176, or performs communication by wireless short-distance transmission 178, wherein the means of wireless short-distance transmission 178 includes Bluetooth and NFC.

Step 316: the authentication module 160 of the information handling system 100 determines whether the specific lifetime of the authentication data with a specific lifetime has elapsed. The process flow of the method will go to step 320 if the determination is affirmative. The process flow of the method will go to step 324 if the determination is negative.

Step 320: the specific lifetime of the authentication data with a specific lifetime has elapsed, and thus the authentication process is not performed, and the authentication module 160 of the controller 156 performs logging and timestamp, wherein the authentication module 160 sends information about the authentication failure of the device 148 and about the fact that the information handling system 100 remains locked, via a network, for example, to a configuration Webpage (not shown) of the device 148, wherein related data is sent by a conventional transmission technique. The recording effectuated through logging and timestamp is targeted at expiry dates, purposes of use, and authorized users' names, to further manage utilization status, detect abnormal messages, send and display alert messages, collect user preference data by numerical analysis, and analyze user behavior, for example.

Step 324: if the specific lifetime of the authentication data with a specific lifetime does not elapse, the authentication module 160 of the information handling system 100 will determine whether the information handling system 100 and the mobile device 174 are successfully authenticated. In case of authentication failure, the process flow of the method will go to step 328. In case of authentication success, the process flow of the method will go to step 332. In an embodiment, with a conventional public/private key authentication technique, the authentication is deemed a success when the public key and the private key are matched paired keys, and the authentication is deemed a failure when the public key and the private key are non-matched paired keys.

Step 328: the authentication module 160 of the controller 156 performs logging and timestamp in response to the authentication failure. The controller 156 keeps the latch component 172 at a locked position and keeps the information handling system 100 in a locked status, and thus it is impossible to access the information handling system 100. The authentication module 160 sends information about the authentication failure of the device 148 and about the fact that the information handling system 100 remains locked, via a network, for example, to the device 148. The recording effectuated through logging and timestamp is targeted at expiry dates, purposes of use, and authorized users' names, to further manage utilization status, detect abnormal messages, send and display alert messages, collect user preference data by numerical analysis, and analyze user behavior, for example. The aforesaid recording, management, alert, and analysis are well-known among persons skilled in the art.

Step 332: in response to the authentication success, the controller 156 causes the latch component 172 to be activated to the unlocked position, such that the chassis 120 and the cover 180 operate in conjunction with each other to effectuate unlocking and further access the interior of the information handling system 100.

Step 336: the authentication module 160 of the information handling system 100 determines whether the specific lifetime of the authentication data with a specific lifetime has elapsed. The process flow of the method will go to step 340 when the determination is affirmative. The process flow of the method will go to step 316 when the determination is negative.

Step 340: in response to an elapse of the specific lifetime, the authentication module 160 of the controller 156 invalidates the authentication data and instructs the controlling/receiving module 162 to activate the latch component 172 to the latched position to begin locking the chassis 120 and the cover 180.

By making reference to authentication data with a specific lifetime, the information handling system 100 of the present invention effectively carries out security control management of hardware/software/data, effectuates complete recording and analysis through logging and timestamp, and further enhances access security of the information handling system 100. Moreover, the present invention is not restricted to the server, because any housing-equipped electronic device, hard disk drive, or a combination thereof is applicable to the present invention. In addition, persons skilled in the art understand that the present invention is not restricted to the aforesaid authentication and access security technology applicable to the information handling system 100, and thus any means whereby the information handling system 100 effectuates secure access, whether in the form of hardware, software, firmware, or a combination thereof, is applicable to the present invention.

The present invention can be embodied in any other specific way, provided that doing so does not depart from the spirit and essential features of the present invention. Every aspect of the aforesaid specific embodiments is deemed illustrative rather than restrictive. Hence, the scope of the present invention is defined by the accompanying claims rather than the above description. All equivalent meanings and range-bound changes must be regarded as falling within the claims.

What is claimed is:

1. A method of effectuating access security, the method comprising:
sending authentication data with a specific lifetime from a mobile device to an information handling system, the information handling system comprising a controller and a housing, the housing comprising a chassis and a latch component, with the controller electrically coupled to the latch component;
determining by the controller in accordance with the authentication data whether the mobile device is authorized to activate the latch component; and
activating the latch component by the controller to lock or unlock the housing in response to a determination that the mobile device is authorized to activate the latch component.

2. The method of claim 1, wherein determining whether the mobile device is authorized is performed by an authentication process in accordance with the authentication data.

3. The method of claim 2, further comprising:
determining by the controller that the specific lifetime of the authentication data has elapsed;
performing logging and timestamp by the controller and sending information regarding failure of the authentication process and that the information handling system remains locked from the controller to the mobile device in response to one or more of the elapse of the specific lifetime of the authentication data and the failure of the authentication process, and in response to the information handling system remaining locked; and
performing the authentication process in response to the determination that the specific lifetime of the authentication data has not elapsed.

4. The method of claim 3, further comprising:
keeping, by the controller, the latch component at a locked position to continue locking the housing in response to authentication failure of the authentication process; and
activating, by the controller, the latch component to an unlocked position to unlock the housing in response to authentication success of the authentication process.

5. The method of claim 4, further comprising:
determining by the controller whether the specific lifetime has elapsed; and
invalidating the authentication data and activating the latch component to the locked position by the controller in response to an elapse of the specific lifetime.

6. The method of claim 1, wherein the controller comprises one of an integrated management module (IMM), a baseboard management controller (BMC), and a service processor.

7. The method of claim 1, wherein the mobile device comprises one of a cell phone, a portable authentication device, and a universal serial bus (USB) flash drive, wherein the housing further comprises a cover, and the latch component activates to lock the cover and the chassis.
